(19) United States
(12) Patent Application Publication
(10) Pub. No.: US 2026/0322136 A1
(43) Pub. Date: Oct. 15, 2026

(54) ELECTRIC APPARATUS

(71) Applicant: HONDA MOTOR CO., LTD., Tokyo (JP)

(72) Inventors: Yoshihisa Kubota, Wako-shi (JP); Somei Nakatomi, Wako-shi (JP)

(21) Appl. No.: 19/467,866

(22) Filed: Feb. 3, 2026

(30) Foreign Application Priority Data
Mar. 31, 2025 (JP) 2025-058246

(51) Int. Cl. H02J 7/06; H02P 27/06

(52) U.S. Cl. CPC H02J 7/06; H02P 27/06

(57) ABSTRACT

An electric apparatus includes: an electric power control unit that controls electric power transfer of each of an electric power storage device and a rotary electric machine; and an AC charging terminal that connects the electric power control unit to an external AC electric power source. The electric power control unit includes a first full-bridge circuit, a second full-bridge circuit, a first connection-disconnection device, a second connection-disconnection device, and a control device. The AC charging terminal is connected to both ends of each of the first connection-disconnection device and the second connection-disconnection device such that when a current supplied from the external AC electric power source flows to a first coil and a second coil, magnetic fluxes of the first coil and the second coil cancel each other. The control device controls the first connection-disconnection device and the second connection-disconnection device to be in a disconnection state at a time of AC charging in which the electric power storage device is charged by electric power supplied from the external AC electric power source, supplies electric power to both of the first coil and the second coil when a charging torque generated at the time of AC charging is equal to or more than a predetermined value, and supplies electric power to one of the first coil and the second coil when the charging torque is less than the predetermined value.

### CROSS-REFERENCE TO RELATED APPLICATION

Priority is claimed on Japanese Patent Application No. 2025-058246, filed on Mar. 31, 2025, the contents of which are incorporated herein by reference.

### BACKGROUND

### Field of the Invention

The present invention relates to an electric apparatus.

### Background

In recent years, in order to ensure that more people have access to affordable, reliable, sustainable, and advanced energy, research and development relating to charging and electric power supply in a mobility on which a secondary battery is mounted, which contributes to energy efficiency, has been conducted.

In the related art, for example, an electric vehicle is known which converts AC electric power supplied from an external electric power source into DC electric power by a combination of stator windings of a plurality of phases of a motor and bridge circuits of a plurality of phases by switching elements (for example, refer to Japanese Unexamined Patent Application, First Publication No. 2012-70613). In this electric vehicle, by a current from the external electric power source being supplied to a connection point that divides the stator winding of each phase into two, magnetic fluxes in a magnetic circuit of the motor cancel each other, and generation of a torque is prevented.

### SUMMARY

In the technique relating to charging and electric power supply in a mobility on which a secondary battery is mounted, a problem to be solved is improving the charging efficiency of AC charging by the external electric power source. For example, as in the electric vehicle of the related art described above, in the case where a magnetic flux coupling to each other is decreased by including a plurality of coils on the divided stator winding of each phase and an effective inductance is increased for ease of control, there is a possibility that it becomes difficult to increase a voltage increase ratio. If it is difficult to increase the voltage increase ratio at the time of conversion from AC electric power to DC electric power, another voltage increase operation is required to ensure a desired DC voltage, and there is a possibility that it becomes difficult to improve the charging efficiency.

The present application aims to improve the charging efficiency at the time of AC charging. Further, the present application contributes to energy efficiency.

An electric apparatus according to a first aspect of the present invention includes: an electric power storage device; a rotary electric machine; an electric power control unit that is connected to the electric power storage device and the rotary electric machine and controls electric power transfer of each of the electric power storage device and the rotary electric machine; and an AC charging terminal that connects the electric power control unit to an external AC electric power source, wherein the rotary electric machine includes a first coil and a second coil, the electric power control unit includes a first full-bridge circuit that is connected to both ends of the first coil, a second full-bridge circuit that is connected to both ends of the second coil, a first connection-disconnection device that is connected between the first full-bridge circuit and one end of the first coil, a second connection-disconnection device that is connected between the second full-bridge circuit and one end of the second coil, and a control device that controls electric power supply to the first coil and the second coil, the AC charging terminal is connected to both ends of each of the first connection-disconnection device and the second connection-disconnection device such that when a current supplied from the external AC electric power source flows to the first coil and the second coil that are magnetically coupled, magnetic fluxes of the first coil and the second coil cancel each other, and the control device controls the first connection-disconnection device and the second connection-disconnection device to be in a disconnection state at a time of AC charging in which the electric power storage device is charged by electric power supplied from the external AC electric power source, supplies electric power to both of the first coil and the second coil when a charging torque generated at the time of AC charging is equal to or more than a predetermined value, and supplies electric power to one of the first coil and the second coil when the charging torque is less than the predetermined value.

A second aspect of the electric apparatus according to the first aspect described above may further include: a position sensor that detects a rotor angle of the rotary electric machine, wherein the control device may calculate the charging torque based on the rotor angle obtained from an output signal of the position sensor.

A third aspect is the electric apparatus according to the first aspect described above, wherein in the rotary electric machine, the first coil and the second coil may be wound around an identical slot of an identical phase, and the control device may control a flow direction of a current supplied from the external AC electric power source such that the magnetic fluxes of the first coil and the second coil cancel each other when supplying electric power to both of the first coil and the second coil.

A fourth aspect is the electric device according to any one of the first to third aspects described above, wherein the rotary electric machine may include a third coil and a fourth coil having a phase that is orthogonal to the first coil and the second coil, and the electric power control unit may include a third full-bridge circuit that is connected to both ends of the third coil, a fourth full-bridge circuit that is connected to both ends of the fourth coil, a third connection-disconnection device that is connected between positive electrodes of the third full-bridge circuit and the fourth full-bridge circuit, and a fourth connection-disconnection device that is connected between negative electrodes of the third full-bridge circuit and the fourth full-bridge circuit.

A fifth aspect is the electric apparatus according to the fourth aspect described above, wherein in the rotary electric machine, the third coil and the fourth coil may be wound around an identical slot.

According to the first aspect, when the charging torque at the time of AC charging is equal to or more than the predetermined value, by supplying electric power to both of the first coil and the second coil such that the magnetic fluxes of the first coil and the second coil cancel each other, it is possible to reduce oscillation of the charging torque that is generated in the rotary electric machine, and it is possible to increase a voltage increase ratio by a relatively small inductance. On the other hand, when the charging torque at the time of AC charging is less than the predetermined value, it is possible to improve the charging efficiency by supplying electric power to one of the first coil and the second coil while reducing the ripple of the current by a relatively large inductance.

According to the second aspect, since the charging torque that changes depending on the rotor angle can be calculated with high accuracy, the time at which the charging torque exceeds the predetermined value can be detected with high accuracy.

According to the third aspect, by employing a structure in which the first coil and the second coil are wound around the identical slot of the identical phase in the rotary electric machine and by supplying electric power to both of the first coil and the second coil such that the magnetic fields of the first coil and the second coil cancel each other, it is possible to reduce oscillation of the charging torque that is generated in the rotary electric machine, and it is possible to increase a voltage increase ratio by a relatively small inductance.

According to the fourth aspect, at the time of driving the rotary electric machine by the electric power storage device, it is possible to cause the electric power control unit to function as an inverter of a multiplex full-bridge circuit. At the time of AC charging of the electric power storage device by the external AC electric power source, it is possible to cause the combination of the third coil, the fourth coil, the third full-bridge circuit, and the fourth full-bridge circuit to function as an insulation-type bidirectional DC-DC converter. For example, in the case of the voltage increase operation at the time of AC charging, it is possible to perform quick charging with respect to a voltage of the electric power storage device that is higher than a charging voltage by the external AC electric power source.

According to the fifth aspect, by employing a structure in which the third coil and the fourth coil are wound around the identical slot in the rotary electric machine, a magnetic coupling degree between the third coil and the fourth coil can be enhanced, and therefore, it is possible to improve the charging efficiency.

### BRIEF DESCRIPTION OF THE DRAWINGS

FIG. 1 is a view showing a schematic configuration of an electric apparatus according to the present embodiment.

FIG. 2 is a view schematically showing a configuration of a rotary electric machine of the electrical apparatus according to the present embodiment.

FIG. 3 is a block diagram showing a functional configuration of an electronic control unit of the electric apparatus according to the present embodiment.

FIG. 4 is a view showing a switching pattern of a second electric power conversion portion at the time of two-coil driving.

FIG. 5 is a first timing chart showing a state of each element portion at the time of two-coil driving.

FIG. 6 is a second timing chart showing a state of each element portion at the time of two-coil driving.

FIG. 7 is a third timing chart showing a state of each element portion at the time of two-coil driving.

FIG. 8 is a view showing a direction of a magnetic flux that is generated in the rotary electric machine by a PWM control portion performing the two-coil driving at the time of AC charging.

FIG. 9 is a view showing a switching pattern of a second electric power conversion portion at the time of one-coil driving.

FIG. 10 is a view showing a direction of a magnetic flux that is generated in the rotary electric machine by the PWM control portion performing the one-coil driving at the time of AC charging.

FIG. 11 is a view showing a correspondence relationship between a charging electric power and a charging torque.

FIG. 12 is a flowchart showing a charging control process performed by the PWM control portion of the electric apparatus according to the present embodiment.

FIG. 13 is a view showing an example of a waveform of a current that flows in a β-phase first coil and a waveform of a current that flows in a β-phase second coil at the time of one-coil driving.

FIG. 14 is a view showing an example of a waveform of an electric power source current that flows at the time of one-coil driving.

FIG. 15 is a view showing an example of a waveform of a current that flows in the β-phase first coil and a waveform of a current that flows in the β-phase second coil at the time of two-coil driving.

FIG. 16 is a view showing an example of a waveform of an electric power source current that flows at the time of two-coil driving.

### DESCRIPTION OF EMBODIMENTS

Hereinafter, an embodiment of an electric apparatus according to the present invention will be described with reference to the drawings.

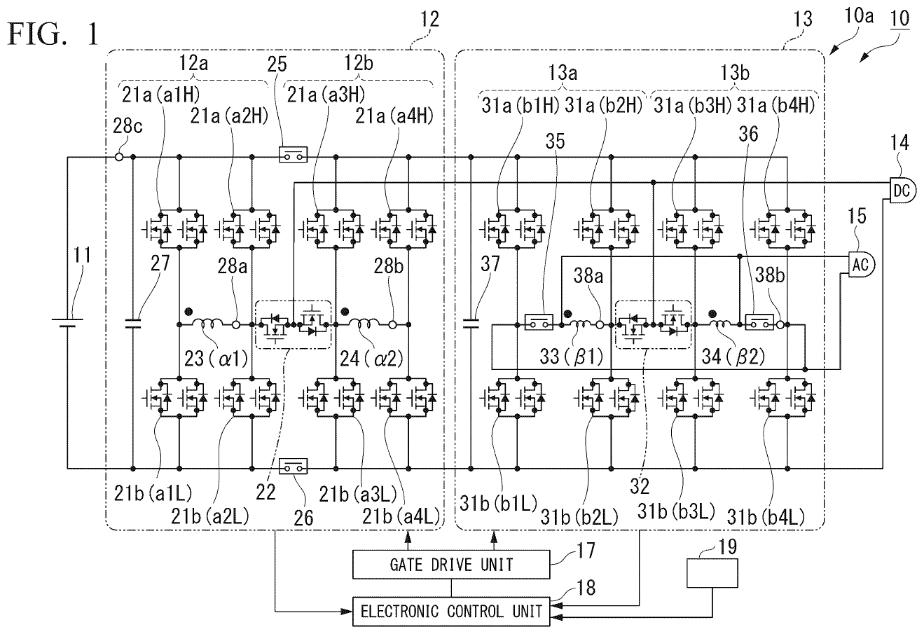

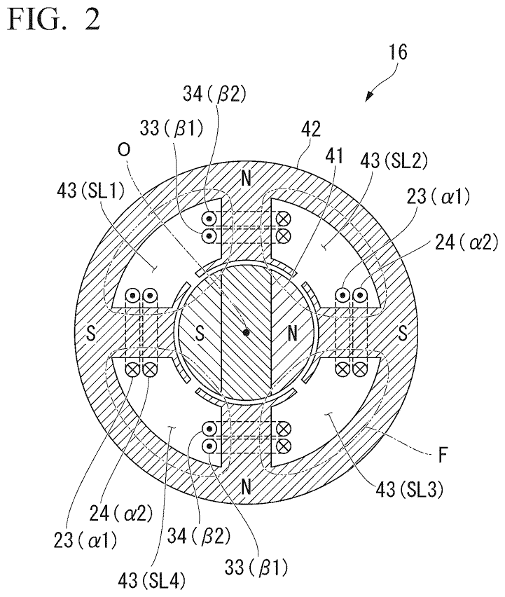

FIG. 1 is a view showing a schematic configuration of an electric apparatus 10 according to the present embodiment. FIG. 2 is a view schematically showing a configuration of a rotary electric machine 16 of the electric apparatus 10.

The electric apparatus 10 is mounted, for example, on an electric vehicle, an electric movable body, an electric machine, an electric power source device, and the like. The electric vehicle is, for example, an electric automobile that includes a rotary electric machine as a power source, a saddle riding vehicle, a kick skater, a hybrid vehicle by a combination of a rotary electric machine and an internal combustion engine, a fuel cell vehicle by a combination of an electric power storage device and a fuel cell, and the like. The electric movable body is, for example, a robot, a flying vehicle, a movable body on water, an underwater movable body, and the like. The electric machine is, for example, a construction machine that includes a rotary electric machine as a power source and the like. The electric power source device is, for example, a stationary or mobile electric power source device that performs discharging and charging of an electric power storage device and the like.

### (Electric Apparatus)

As shown in FIG. 1 and FIG. 2, the electric apparatus 10 includes, for example, an electric power storage device 11, a first electric power conversion portion 12, a second electric power conversion portion 13, a DC charging terminal 14, an AC charging terminal 15, a rotary electric machine 16, a gate drive unit 17, an electronic control unit 18 (control device), and a position sensor 19. For example, the first electric power conversion portion 12, the second electric power conversion portion 13, the DC charging terminal 14, the AC charging terminal 15, the gate drive unit 17, and the electronic control unit 18 constitute an electric power control unit 10a.

The electric power storage device 11 is connected to the first electric power conversion portion 12 and the second electric power conversion portion 13 described later.

The electric power storage device 11 includes, for example, a plurality of battery cells that are connected in series or in parallel. Each battery cell is, for example, a lead storage battery, a lithium-ion battery, a secondary battery such as a nickel hydride battery and an all-solid-state battery, a capacitor such as an electric double layer capacitor, a compound battery by a combination of a secondary battery and a capacitor, or the like. Each battery cell repeatedly performs charging and discharging.

The electric power storage device 11 transfers electric power to and from the rotary electric machine 16 via the electric power control unit 10a. The electric power storage device 11 is charged by an external electric power source (an external DC electric power source and an external AC electric power source).

The first electric power conversion portion 12 includes a first full-bridge circuit 12a (third full-bridge circuit) and a second full-bridge circuit 12b (fourth full-bridge circuit). Each of the first full-bridge circuit 12a and the second full-bridge circuit 12b includes, for example, a so-called H-bridge circuit formed of a plurality of switching elements connected in two phases by bridge connection. Each switching element included in the first full-bridge circuit 12a and the second full-bridge circuit 12b is, for example, a transistor of a SiC (Silicon Carbide) or the like, such as a MOSFET (Metal Oxide Semi-conductor Field Effect Transistor) or an IGBT (Insulated Gate Bipolar Transistor). Each switching element included in the first full-bridge circuit 12a and the second full-bridge circuit 12b is, for example, an N-channel type MOSFET.

The plurality of switching elements included in the first full-bridge circuit 12a and the second full-bridge circuit 12b are, for example, a pair of transistors forming each of high-side arm and low-side arm element portions 21a, 21b that form a pair in each phase. Each pair of transistors of each element portion 21a, 21b is connected, for example, in parallel. Each full-bridge circuit 12a, 12b may include, for example, a rectifier element such as a reflux diode which is connected in parallel between a collector and an emitter of each transistor in a forward direction toward the collector from the emitter.

The first electric power conversion portion 12 includes, for example, a first switch 22 that is connected between a second middle point of the first full-bridge circuit 12a and a third middle point of the second full-bridge circuit 12b. The second middle point of the first full-bridge circuit 12a is, for example, a connection point between a high-side arm element portion 21a (a2H) and a low-side arm element portion 21b (a2L) that are connected in series in a second phase among first and second phases of two phases of the first full-bridge circuit 12a. For example, the second middle point of the first full-bridge circuit 12a is a connection point between a source of the high-side arm element portion 21a (a2H) and a drain of the low-side arm element portion 21b (a2L).

The third middle point of the second full-bridge circuit 12b is, for example, a connection point between a high-side arm element portion 21a (a3H) and a low-side arm element portion 21b (a3L) that are connected in series in a first phase among first and second phases of two phases of the second full-bridge circuit 12b. For example, the third middle point of the second full-bridge circuit 12b is a connection point between a source of the high-side arm element portion 21a (a3H) and a drain of the low-side arm element portion 21b (a3L).

The first switch 22 is, for example, a bidirectional switch formed of two switching elements. Each switching element included in the first switch 22 is a transistor such as a MOSFET or an IGBT and is, for example, an N-channel type MOSFET. The first switch 22 includes, for example, two transistors connected reversely in series. For example, the sources of the two transistors are connected to each other, and thereby, the two transistors are connected in series in a direction opposite to each other. The first switch 22 switches conduction and cutoff of a current between the second middle point of the first full-bridge circuit 12a and the third middle point of the second full-bridge circuit 12b by ON (conduction)/OFF (cutoff) of the two transistors.

Each transistor included in the first switch 22 may include a rectifier element such as a reflux diode which is connected in parallel between a collector and an emitter in a forward direction toward the collector from the emitter.

The first electric power conversion portion 12 is connected to an α-phase first coil 23 (α1) (third coil) and an α-phase second coil 24 (α2) (fourth coil) of the rotary electric machine 16 described later. The α-phase first coil 23 (α1) is connected between a first middle point and the second middle point in the first full-bridge circuit 12a. The first middle point of the first full-bridge circuit 12a is, for example, a connection point between a high-side arm element portion 21a (a1H) and a low-side arm element portion 21b (a1L) that are connected in series in the first phase of the first full-bridge circuit 12a. For example, the first middle point of the first full-bridge circuit 12a is a connection point between a source of the high-side arm element portion 21a (a1H) and a drain of the low-side arm element portion 21b (a1L).

The α-phase second coil 24 (α2) is connected between the third middle point and a fourth middle point in the second full-bridge circuit 12b. The fourth middle point of the second full-bridge circuit 12b is, for example, a connection point between a high-side arm element portion 21a (a4H) and a low-side arm element portion 21b (a4L) that are connected in series in the second phase of the second full-bridge circuit 12b. For example, the fourth middle point of the second full-bridge circuit 12b is a connection point between a source of the high-side arm element portion 21a (a4H) and a drain of the low-side arm element portion 21b (a4L).

The first electric power conversion portion 12 includes a first connection-disconnection device 25 (third connection-disconnection device) that is connected between positive electrodes of the first full-bridge circuit 12a and the second full-bridge circuit 12b and a second connection-disconnection device 26 (fourth connection-disconnection device) that is connected between negative electrodes of the first full-bridge circuit 12a and the second full-bridge circuit 12b. Each of the first connection-disconnection device 25 and the second connection-disconnection device 26 is, for example, a contactor and switches between ON and OFF of the connection between the first full-bridge circuit 12a and the second full-bridge circuit 12b.

The first electric power conversion portion 12 includes, for example, a first capacitor (condenser) 27 that is connected between the positive electrode and the negative electrode. For example, the first capacitor 27 smooths voltage variation generated in accordance with a switching operation between ON and OFF of each switching element of the first electric power conversion portion 12.

The first electric power conversion portion 12 includes a first current sensor 28a, a second current sensor 28b, and a third current sensor 28c. For example, the first current sensor 28a is arranged between the α-phase first coil 23 (α1) and the second middle point of the first full-bridge circuit 12a. The second current sensor 28b is arranged between the α-phase second coil 24 (α2) and the fourth middle point of the second full-bridge circuit 12b. The third current sensor 28c is arranged between the electric power storage device 11 and the first electric power conversion portion 12.

For example, the first current sensor 28a detects a current that flows through the α-phase first coil 23 (α1). The second current sensor 28b detects a current that flows through the α-phase second coil 24 (α2). The third current sensor 28c detects a current that flows between the first electric power conversion portion 12 and the electric power storage device 11.

The second electric power conversion portion 13 includes a third full-bridge circuit 13a (first full-bridge circuit) and a fourth full-bridge circuit 13b (second full-bridge circuit). Each of the third full-bridge circuit 13a and the fourth full-bridge circuit 13b includes, for example, a so-called H-bridge circuit formed of a plurality of switching elements connected in two phases by bridge connection. Each switching element included in the third full-bridge circuit 13a and the fourth full-bridge circuit 13b is, for example, a transistor of a SiC or the like, such as a MOSFET or an IGBT. Each switching element included in the third full-bridge circuit 13a and the fourth full-bridge circuit 13b is, for example, an N-channel type MOSFET.

The plurality of switching elements included in the third full-bridge circuit 13a and the fourth full-bridge circuit 13b are, for example, a pair of transistors forming each of high-side arm and low-side arm element portions 31a, 31b that form a pair in each phase. Each pair of transistors of each element portion 31a, 31b are connected, for example, in parallel.

Each full-bridge circuit 13a, 13b may include, for example, a rectifier element such as a reflux diode which is connected in parallel between a collector and an emitter of each transistor in a forward direction toward the collector from the emitter.

The second electric power conversion portion 13 includes, for example, a second switch 32 that is connected between a sixth middle point of the third full-bridge circuit 13a and a seventh middle point of the fourth full-bridge circuit 13b. The sixth middle point of the third full-bridge circuit 13a is, for example, a connection point between a high-side arm element portion 31a (b2H) and a low-side arm element portion 31b (b2L) that are connected in series in a second phase among first and second phases of two phases of the third full-bridge circuit 13a. For example, the sixth middle point of the third full-bridge circuit 13a is a connection point between a source of the high-side arm element portion 31a (b2H) and a drain of the low-side arm element portion 31b (b2L).

The seventh middle point of the fourth full-bridge circuit 13b is, for example, a connection point between a high-side arm element portion 31a (b3H) and a low-side arm element portion 31b (b3L) that are connected in series in a first phase among first and second phases of two phases of the fourth full-bridge circuit 13b. For example, the seventh middle point of the fourth full-bridge circuit 13b is a connection point between a source of the high-side arm element portion 31a (b3H) and a drain of the low-side arm element portion 31b (b3L).

The second switch 32 is, for example, a bidirectional switch formed of two switching elements. Each switching element included in the second switch 32 is a transistor such as a MOSFET or an IGBT and is, for example, an N-channel type MOSFET. The second switch 32 includes, for example, two transistors connected reversely in series. For example, the sources of the two transistors are connected to each other, and thereby, the two transistors are connected in series in a direction opposite to each other. The second switch 32 switches conduction and cutoff of a current between the sixth middle point of the third full-bridge circuit 13a and the seventh middle point of the fourth full-bridge circuit 13b by ON/OFF of the two transistors.

Each transistor included in the second switch 32 may include a rectifier element such as a reflux diode which is connected in parallel between a collector and an emitter in a forward direction toward the collector from the emitter.

The second electric power conversion portion 13 is connected to a β-phase first coil 33 (β1) (first coil) and a β-phase second coil 34 (β2) (second coil) of the rotary electric machine 16 described later. The β-phase first coil 33 is connected between a fifth middle point and the sixth middle point in the third full-bridge circuit 13a. The fifth middle point of the third full-bridge circuit 13a is, for example, a connection point between a high-side arm element portion 31a (b1H) and a low-side arm element portion 31b (b1L) that are connected in series in the first phase of the third full-bridge circuit 13a. For example, the fifth middle point of the third full-bridge circuit 13a is a connection point between a source of the high-side arm element portion 31a (b1H) and a drain of the low-side arm element portion 31b (b1L).

The β-phase second coil 34 (β2) is connected between the seventh middle point and an eighth middle point in the fourth full-bridge circuit 13b. The eighth middle point of the fourth full-bridge circuit 13b is, for example, a connection point between a high-side arm element portion 31a (b4H) and a low-side arm element portion 31b (b4L) that are connected in series in the second phase of the fourth full-bridge circuit 13b. For example, the eighth middle point of the fourth full-bridge circuit 13b is a connection point between a source of the high-side arm element portion 31a (b4H) and a drain of the low-side arm element portion 31b (b4L).

The second electric power conversion portion 13 includes a third connection-disconnection device 35 (first connection-disconnection device) and a fourth connection-disconnection device 36 (second connection-disconnection device). The third connection-disconnection device 35 is connected between the β-phase first coil 33 (β1) and the fifth middle point of the third full-bridge circuit 13a. The fourth connection-disconnection device 36 is connected between the β-phase second coil 34 (β2) and the eighth middle point of the fourth full-bridge circuit 13b. Each of the third connection-disconnection device 35 and the fourth connection-disconnection device 36 is, for example, a contactor. The third connection-disconnection device 35 switches between ON and OFF of the connection between the β-phase first coil 33 (β1) and the fifth middle point of the third full-bridge circuit 13a. The fourth connection-disconnection device 36 switches between ON and OFF of the connection between the β-phase second coil 34 (β2) and the eighth middle point of the fourth full-bridge circuit 13b.

The second electric power conversion portion 13 includes, for example, a second capacitor (condenser) 37 that is connected between the positive electrode and the negative electrode. For example, the second capacitor 37 smooths voltage variation generated in accordance with a switching operation between ON and OFF of each switching element of the second electric power conversion portion 13.

The second electric power conversion portion 13 includes a fourth current sensor 38a and a fifth current sensor 38b. The fourth current sensor 38a is arranged between the β-phase first coil 33 (β1) and the sixth middle point of the third full-bridge circuit 13a. The fifth current sensor 38b is arranged between the β-phase second coil 34 (β2) and the eighth middle point of the fourth full-bridge circuit 13b. For example, the fourth current sensor 38a detects a current that flows through the β-phase first coil 33 (β1). The fifth current sensor 38b detects a current that flows through the β-phase second coil 34 (β2).

The DC charging terminal 14 and the AC charging terminal 15 include, for example, a connection device (connector) or the like for DC electric power and for AC electric power of a predetermined standard. The DC charging terminal 14 and the AC charging terminal 15 are connected, for example, to a DC electric power source (external DC electric power source) and an AC electric power source (external AC electric power source) at the outside on the basis of a commercial electric power source or the like that is connected to an electric power system.

The DC charging terminal 14 is connected to the negative electrode of the second electric power conversion portion 13 and to a middle point (that is, a point between the two transistors connected reversely in series) of each of the first switch 22 and the second switch 32. The AC charging terminal 15 is connected to the fifth middle point of the third full-bridge circuit 13a and to the eighth middle point of the fourth full-bridge circuit 13b. Further, the AC charging terminal 15 is connected to a connection point between the β-phase first coil 33 (β1) and the third connection-disconnection device 35 and is connected to a connection point between the β-phase second coil 34 (β2) and the fourth connection-disconnection device 36.

The rotary electric machine 16 is, for example, a two-phase AC brushless DC motor. As shown in FIG. 2, the rotary electric machine 16 includes, for example, the α-phase first coil 23 (α1), the α-phase second coil 24 (α2), the β-phase first coil 33 (β1), the β-phase second coil 34 (β2), a rotor 41, and a stator core 42. The rotor 41 includes a field permanent magnet. Each coil α1, α2, β1, β2 that generates a rotating magnetic field which rotates the rotor 41 is attached to the stator core 42.

The α-phase first coil 23 (α1), the α-phase second coil 24 (α2), the β-phase first coil 33 (β1), and the β-phase second coil 34 (β2) are so-called open-ended coils, and ends of the coils α1, α2, β1, β2 are not connected to each other (that is, the coils α1, α2, β1, β2 are separated from each other) and are drawn out to the outside of the rotary electric machine 16.

The α-phase first coil 23 (α1) and the α-phase second coil 24 (α2) set, for example, a spatial phase difference from each other to be zero and are wound with respect to the teeth of the stator core 42 in an identical direction when seen from an axis line direction along a center axis O of the rotary electric machine 16. The α-phase first coil 23 (α1) and the α-phase second coil 24 (α2) are arranged, for example, so as to share or respectively occupy part of a slot 43 formed in the stator core 42 and are magnetically coupled to each other in an identical polarity.

The β-phase first coil 33 (β1) and the β-phase second coil 34 (β2) set, for example, a spatial phase difference from each other to be zero and are wound with respect to the teeth of the stator core 42 in an identical direction when seen from the axis line direction along the center axis O of the rotary electric machine 16. The β-phase first coil 33 (β1) and the β-phase second coil 34 (β2) are arranged, for example, so as to share or respectively occupy part of the slot 43 formed in the stator core 42 and are magnetically coupled to each other in an identical polarity.

The α-phase first coil 23 (α1), the α-phase second coil 24 (α2), the β-phase first coil 33 (β1), and the β-phase second coil 34 (β2) are arranged such that the α-phase first coil 23 (α1) and the α-phase second coil 24 (α2) do not magnetically interfere with the β-phase first coil 33 (β1) and the β-phase second coil 34 (β2) by setting the spatial phase difference from each other to be 90°. For example, each coil α1, α2, β1, β2 is attached to the stator core 42 by concentrated winding, distributed winding, or the like.

For example, in the rotary electric machine 16, the β-phase first coil 33 (β1) and the β-phase second coil 34 (β2) are wound around an identical slot 43 of an identical phase, and the α-phase first coil 23 (α1) and the α-phase second coil 24 (α2) are wound around the identical slot 43. Specifically, the β-phase first coil 33 (β1) and the β-phase second coil 34 (β2) are wound around a first slot SL1 and a second slot SL2 and are also wound around a third slot SL3 and a fourth slot SL4. The α-phase first coil 23 (α1) and the α-phase second coil 24 (α2) are wound around the first slot SL1 and the fourth slot SL4 and are also wound around the second slot SL2 and the third slot SL3.

The rotary electric machine 16 generates rotation power by performing a power running operation using electric power that is supplied from the first electric power conversion portion 12 and the second electric power conversion portion 13. For example, when the rotary electric machine 16 is connected to a wheel of a vehicle, the rotary electric machine 16 generates a travel drive force by the electric power that is supplied from the first electric power conversion portion 12 and the second electric power conversion portion 13. The rotary electric machine 16 may generate electric power by performing a regeneration operation using rotation power that is input from a wheel side of the vehicle. For example, when the rotary electric machine 16 is connected to an internal combustion engine of the vehicle, the rotary electric machine 16 may generate electric power using the power of the internal combustion engine.

The gate drive unit 17 switches between ON and OFF of each connection-disconnection device 25, 26, 35, 36 and each switching element of the first electric power conversion portion 12 and the second electric power conversion portion 13 on the basis of a control signal that is received from the electronic control unit 18. For example, the gate drive unit 17 switches between ON and OFF of each switching element of each full-bridge circuit 12a, 12b, 13a, 13b by outputting a gate signal generated by amplification, level shift, and the like of the control signal.

The position sensor 19 detects a rotation angle of the rotor 41 of the rotary electric machine 16 as a rotor angle θ and outputs an analog signal indicating a detection result of the rotor angle θ to the electronic control unit 18. For example, the position sensor 19 is a resolver that is attached to a rotor shaft (not shown) of the rotary electric machine 16.

The electronic control unit 18 integrally controls an operation of each of the electric power control unit 10a and the rotary electric machine 16. For example, the electronic control unit 18 is a software function unit that functions by a predetermined program being executed by a processor such as a CPU (Central Processing Unit). The software function unit is an ECU (Electronic Control Unit) that includes the processor such as a CPU, a ROM (Read Only Memory) that stores the program, a RAM (Random Access Memory) that temporarily stores data, and an electronic circuit such as a timer. At least part of the electronic control unit 18 may be an integrated circuit such as a LSI (Large Scale Integration).

The electronic control unit 18 generates a control signal indicating a timing when each connection-disconnection device 25, 26, 35, 36 and each switching element of the first electric power conversion portion 12 and the second electric power conversion portion 13 are driven to ON and OFF. The electronic control unit 18 outputs the generated control signal to the gate drive unit 17. (Control operation of electric apparatus)

The electronic control unit 18 sets the first connection-disconnection device 25 and the second connection-disconnection device 26 to be in an ON state in the case of the power running operation or the regeneration operation of the rotary electric machine 16. The electronic control unit 18 switches between a state in which the α-phase coils α1, α2 are connected in series and the β-phase coils β1, β2 are connected in series, and a state in which the α-phase coils α1, α2 are connected in parallel and the β-phase coils β1, β2 are connected in parallel by the switching between ON and OFF of the first switch 22 and the second switch 32.

The electronic control unit 18 performs, for example, a feedback control or the like of a current in which a current detection value of the rotary electric machine 16 and a current target value in response to a torque command value of the rotary electric machine 16 are used and generates a control signal that commands the driving of each switching element of the first electric power conversion portion 12 and the second electric power conversion portion 13.

At the time of DC charging, that is, when the electric power storage device 11 is charged by the external DC electric power source that is connected to the DC charging terminal 14, the electronic control unit 18 sets the first connection-disconnection device 25 and the second connection-disconnection device 26 to be in an ON state. The electronic control unit 18 causes each of the combination of the α-phase coils α1, α2 and the first electric power conversion portion 12 and the combination of the β-phase coils β1, β2 and the second electric power conversion portion 13 to function as a non-insulation type DC-DC converter that performs a voltage increase operation by a so-called chopper control, for example, with respect to the external DC electric power source having a lower voltage than that of the electric power storage device 11.

At the time of AC charging, that is, when the electric power storage device 11 is charged by the external AC electric power source that is connected to the AC charging terminal 15, the electronic control unit 18 sets the first connection-disconnection device 25 and the second connection-disconnection device 26 to be in an OFF state for insulation.

The electronic control unit 18 sets, for example, the α-phase first coil 23 (α1) and the α-phase second coil 24 (α2) that are magnetically coupled to each other in the identical polarity to be a coil of a DC conversion phase (α phase) used for conversion between DC electric power. The electronic control unit 18 causes, for example, the combination of the α-phase coils α1, α2 and the first electric power conversion portion 12 to function as a DAB (Dual Active Bridge) type DC-DC converter which is an insulation-type bidirectional (voltage increase and voltage decrease) converter.

The electronic control unit 18 sets, for example, the β-phase first coil 33 (β1) and the β-phase second coil 34 (β2) that are magnetically coupled to each other in the identical polarity to be a coil of an AC input phase (β phase) that is connected to the external AC electric power source. The electronic control unit 18 causes, for example, the combination of the β-phase coils β1, β2 and the second electric power conversion portion 13 to function as a so-called full-bridgeless type (or bridgeless and totem pole type) power factor correction (PFC) circuit which converts AC electric power into DC electric power. The so-called bridgeless PFC is a PFC that does not include a bridge rectifier by a plurality of diodes which are connected by bridge connection. The so-called totem pole PFC is a PFC that includes a pair of switching elements of an identical conductivity type which are connected (totem pole connection) in series in an identical direction. The electronic control unit 18 performs the power factor correction of an input voltage Vac and an input current Iac while performing rectification of AC electric power that is received from the external AC electric power source into DC electric power and increasing the voltage, for example, by controlling the switching of each switching element in each full-bridge circuit 13a, 13b of the second electric power conversion portion 13.

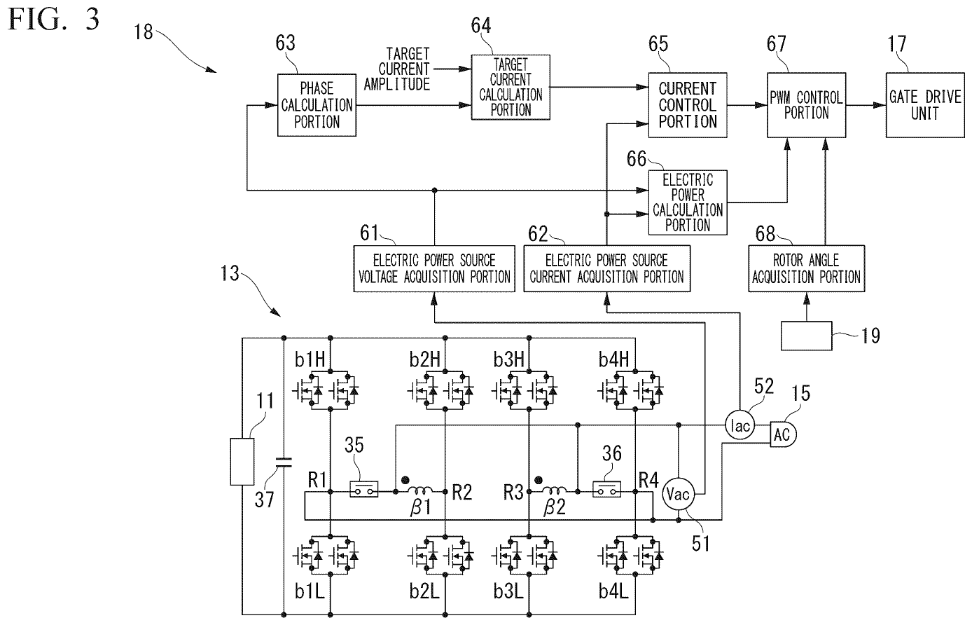

FIG. 3 is a block diagram showing a functional configuration of the electronic control unit 18 at the time of AC charging in the electric apparatus 10. As shown in FIG. 3, the second electric power conversion portion 13 includes, for example, an input voltage sensor 51 that detects an input voltage Vac of the external AC electric power source and an input current sensor 52 that detects an input current Iac of the external AC electric power source.

In FIG. 3, reference numeral R1 represents the fifth middle point of the third full-bridge circuit 13a, and reference numeral R2 represents the sixth middle point of the third full-bridge circuit 13a. Further, in FIG. 3, reference numeral R3 represents the seventh middle point of the fourth full-bridge circuit 13b, and reference numeral R4 represents the eighth middle point of the fourth full-bridge circuit 13b.

The electronic control unit 18 includes, for example, an electric power source voltage acquisition portion 61, an electric power source current acquisition portion 62, a phase calculation portion 63, a target current calculation portion 64, a current control portion 65, an electric power calculation portion 66, a PWM (Pulse Width Modulation) control portion 67, and a rotor angle acquisition portion 68.

The electric power source voltage acquisition portion 61 outputs, for example, the input voltage Vac acquired from the input voltage sensor 51. The electric power source current acquisition portion 62 outputs, for example, the input current Iac acquired from the input current sensor 53. The phase calculation portion 63 calculates, for example, a phase of the input voltage Vac that is output from the electric power source voltage acquisition portion 61. The target current calculation portion 64 calculates a target current that is synchronized with the input voltage Vac, for example, on the basis of a target current amplitude with respect to the input current Iac and the phase of the input voltage Vac that is output from the phase calculation portion 63.

The current control portion 65 outputs a duty ratio of a voltage command, for example, by a PI (proportional and integral) control or the like on the basis of a current deviation obtained by subtraction between the target current that is output from the target current calculation portion 64 and the input current Iac that is output from the electric power source current acquisition portion 62. The duty ratio of the voltage command defines a ratio of an ON time to a switching cycle of the switching elements (that is, the high-side arm and low-side arm switching elements of each phase) that form a pair in each phase of each full-bridge circuit 13a, 13b of the second electric power conversion portion 13. In the following description, the duty ratio of the voltage command may be referred to as a duty command value.

The electric power calculation portion 66 outputs, for example, electric power source electric power obtained by multiplication between the input voltage Vac that is output from the electric power source voltage acquisition portion 61 and the input current Iac that is output from the electric power source current acquisition portion 62. The rotor angle acquisition portion 68 converts an analog signal that is output from the position sensor 19 into a digital signal and thereby outputs a digital signal indicating the rotor angle θ (electric angle).

For example, the rotor angle acquisition portion 68 is an R/D converter.

The PWM control portion 67 performs pulse width modulation on the basis of the duty command value and a carrier wave CW and thereby generates a control signal indicating the time of driving each element portion b1H, b1L, b2H, b2L, b3H, b3L, b4H, b4L included in the second electric power conversion portion 13 to be ON and OFF. For example, the carrier wave CW is a triangular wave.

Hereinafter, an operation of the PWM control portion 67 at the time of AC charging is described in detail.

At the time of AC charging, the third connection-disconnection device 35 and the fourth connection-disconnection device 36 included in the second electric power conversion portion 13 are controlled to be in an OFF state (disconnection state) by the electronic control unit 18.

At the time of AC charging, the PWM control portion 67 switches between two-coil driving and one-coil driving in accordance with the charging torque and thereby charges the electric power storage device 11. The two-coil driving means that electric power is supplied to both of the β-phase first coil 33 (β1) and the β-phase second coil 34 (β2). The one-coil driving means that electric power is supplied to one of the β-phase first coil 33 (β1) and the β-phase second coil 34 (β2). For example, at the time of one-coil driving, the PWM control portion 67 supplies electric power to the β-phase first coil 33 (β1).

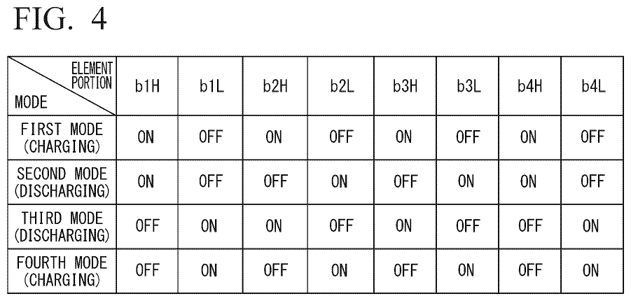

FIG. 4 is a view showing a switching pattern of the second electric power conversion portion 13 at the time of two-coil driving. In a first mode, the high-side arm element portions b1H, b2H, b3H, b4H are in an ON state, and the low-side arm element portions b1L, b2L, b3L, b4L are in an OFF state. In such a first mode, an alternating current flows through both of the β-phase first coil 33 (β1) and the β-phase second coil 34 (β2), and both of the β-phase first coil 33 (β1) and the β-phase second coil 34 (β2) are charged. Here, “charging” means that magnetic energy generated by an alternating current flowing through each coil is accumulated in each coil.

In a second mode, the high-side arm element portions b1H, b4H are in an ON state, the high-side arm element portions b2H, b3H are in an OFF state, the low-side arm element portions b1L, b4L are in an OFF state, and the low-side arm element portions b2L, b3L are in an ON state. In such a second mode, both of the β-phase first coil 33 (β1) and the β-phase second coil 34 (β2) are discharged. Here, “discharging” means that magnetic energy accumulated in each coil is discharged as electric energy (current).

In a third mode, the high-side arm element portions b1H, b4H are in an OFF state, the high-side arm element portions b2H, b3H are in an ON state, the low-side arm element portions b1L, b4L are in an ON state, and the low-side arm element portions b2L, b3L are in an OFF state. In such a third mode, both of the β-phase first coil 33 (β1) and the β-phase second coil 34 (β2) are discharged.

In a fourth mode, the high-side arm element portions b1H, b2H, b3H, b4H are in an OFF state, and the low-side arm element portions b1L, b2L, b3L, b4L are in an ON state. In such a fourth mode, an alternating current flows through both of the β-phase first coil 33 (β1) and the β-phase second coil 34 (β2), and both of the β-phase first coil 33 (β1) and the β-phase second coil 34 (β2) are charged.

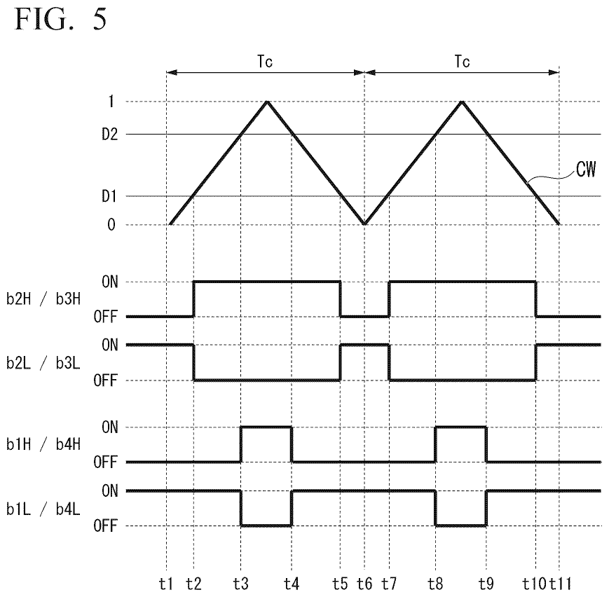

FIG. 5 is a first timing chart showing a state of each element portion at the time of two-coil driving. In FIG. 5, a period from a time t1 to a time t6 and a period from the time t6 to a time t11 correspond to one cycle Tc of the carrier wave CW. As shown in FIG. 5, the duty command value includes a first duty command value D1 and a second duty command value D2. FIG. 5 shows the case where the first duty command value D1 is equal to or more than 0 and less than 0.5. The second duty command value D2 is a value obtained by subtracting the first duty command value D1 from 1.

At the time of two-coil driving, the PWM control portion 67 compares the magnitude of the first duty command value D1 with the magnitude of the carrier wave CW, and when the first duty command value D1 is less than the value of the carrier wave CW, the PWM control portion 67 generates a control signal such that the high-side arm element portions b2H, b3H are in an OFF state, and the low-side arm element portions b2L, b3L are in an ON state. Further, at the time of two-coil driving, when the first duty command value D1 is equal to or more than the value of the carrier wave CW, the PWM control portion 67 generates a control signal such that the high-side arm element portions b2H, b3H are in an ON state, and the low-side arm element portions b2L, b3L are in an OFF state.

At the time of two-coil driving, the PWM control portion 67 compares the magnitude of the second duty command value D2 with the magnitude of the carrier wave CW, and when the second duty command value D2 is less than the value of the carrier wave CW, the PWM control portion 67 generates a control signal such that the high-side arm element portions b1H, b4H are in an OFF state, and the low-side arm element portions b1L, b4L are in an ON state. Further, at the time of two-coil driving, when the second duty command value D2 is equal to or more than the value of the carrier wave CW, the PWM control portion 67 generates a control signal such that the high-side arm element portions b1H, b4H are in an ON state, and the low-side arm element portions b1L, b4L are in an OFF state.

As a result, when the first duty command value D1 is equal to or more than 0 and less than 0.5 at the time of two-coil driving, both of the β-phase first coil 33 (β1) and the β-phase second coil 34 (β2) are charged by a switching pattern of the fourth mode in a period from the time t1 to a time t2.

In a period from the time t2 to a time t3, both of the β-phase first coil 33 (β1) and the β-phase second coil 34 (β2) are discharged by a switching pattern of the third mode. In a period from the time t3 to a time t4, both of the β-phase first coil 33 (β1) and the β-phase second coil 34 (β2) are charged by a switching pattern of the first mode. In a period from the time t4 to a time t5, both of the β-phase first coil 33 (β1) and the β-phase second coil 34 (β2) are discharged by the switching pattern of the third mode. In a period from the time t5 to the time t6, both of the β-phase first coil 33 (β1) and the β-phase second coil 34 (β2) are charged by the switching pattern of the fourth mode.

Similarly, when the first duty command value D1 is equal to or more than 0 and less than 0.5 at the time of two-coil driving, both of the β-phase first coil 33 (β1) and the β-phase second coil 34 (β2) are charged by the switching pattern of the fourth mode in a period from the time t6 to a time t7. In a period from the time t7 to a time t8, both of the β-phase first coil 33 (β1) and the β-phase second coil 34 (β2) are discharged by the switching pattern of the third mode. In a period from the time t8 to a time t9, both of the β-phase first coil 33 (β1) and the β-phase second coil 34 (β2) are charged by the switching pattern of the first mode. In a period from the time t9 to a time t10, both of the β-phase first coil 33 (β1) and the β-phase second coil 34 (β2) are discharged by the switching pattern of the third mode. In a period from the time t10 to the time t11, both of the β-phase first coil 33 (β1) and the β-phase second coil 34 (β2) are charged by the switching pattern of the fourth mode.

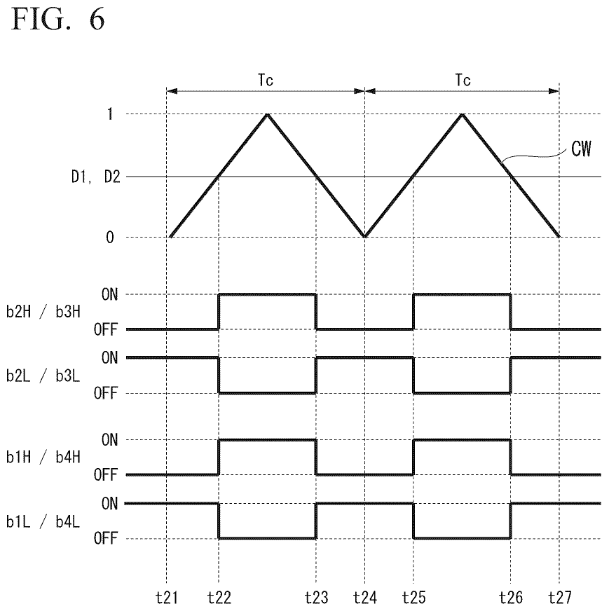

FIG. 6 is a second timing chart showing a state of each element portion at the time of two-coil driving. In FIG. 6, a period from a time t21 to a time t24 and a period from the time t24 to a time t27 correspond to one cycle Tc of the carrier wave CW. FIG. 6 shows the case where the first duty command value D1 is 0.5. That is, the second duty command value D2 is also 0.5.

As shown in FIG. 6, when the first duty command value D1 is 0.5 at the time of two-coil driving, both of the β-phase first coil 33 (β1) and the β-phase second coil 34 (β2) are charged by the switching pattern of the fourth mode in a period from the time t21 to a time t22. In a period from the time t22 to a time t23, both of the β-phase first coil 33 (β1) and the β-phase second coil 34 (β2) are charged by the switching pattern of the first mode.

In a period from the time t23 to the time t24, both of the β-phase first coil 33 (β1) and the β-phase second coil 34 (β2) are charged by the switching pattern of the fourth mode.

Similarly, when the first duty command value D1 is 0.5 at the time of two-coil driving, both of the β-phase first coil 33 (β1) and the β-phase second coil 34 (β2) are charged by the switching pattern of the fourth mode in a period from the time t24 to a time t25. In a period from the time t25 to a time t26, both of the β-phase first coil 33 (β1) and the β-phase second coil 34 (β2) are charged by the switching pattern of the first mode. In a period from the time t26 to the time t27, both of the β-phase first coil 33 (β1) and the β-phase second coil 34 (β2) are charged by the switching pattern of the fourth mode.

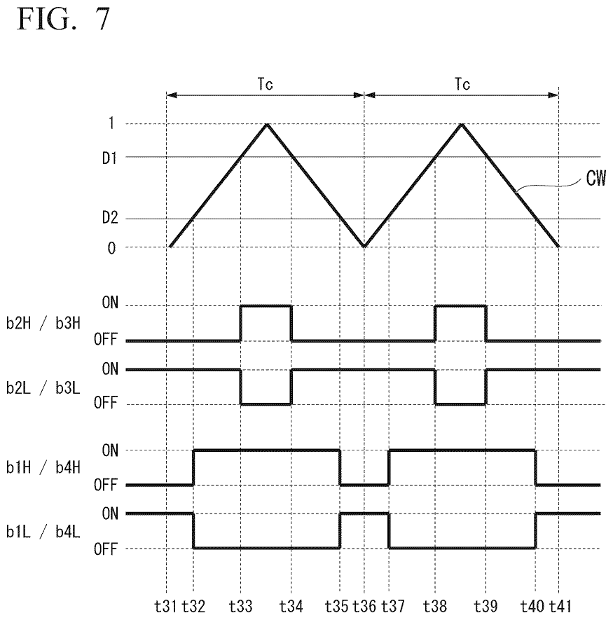

FIG. 7 is a third timing chart showing a state of each element portion at the time of two-coil driving. In FIG. 7, a period from a time t31 to a time t36 and a period from the time t36 to a time t41 correspond to one cycle Tc of the carrier wave CW. FIG. 7 shows the case where the first duty command value D1 is equal to or less than 1 and more than 0.5.

As shown in FIG. 7, when the first duty command value D1 is equal to or less than 1 and more than 0.5 at the time of two-coil driving, both of the β-phase first coil 33 (β1) and the β-phase second coil 34 (β2) are charged by the switching pattern of the fourth mode in a period from the time t31 to a time t32. In a period from the time t32 to a time t33, both of the β-phase first coil 33 (β1) and the β-phase second coil 34 (β2) are discharged by a switching pattern of the second mode. In a period from the time t33 to a time t34, both of the β-phase first coil 33 (β1) and the β-phase second coil 34 (β2) are charged by the switching pattern of the first mode. In a period from the time t34 to a time t35, both of the β-phase first coil 33 (β1) and the β-phase second coil 34 (β2) are discharged by the switching pattern of the second mode. In a period from the time t35 to the time t36, both of the β-phase first coil 33 (β1) and the β-phase second coil 34 (β2) are charged by the switching pattern of the fourth mode.

Similarly, when the first duty command value D1 is equal to or less than 1 and more than 0.5 at the time of two-coil driving, both of the β-phase first coil 33 (β1) and the β-phase second coil 34 (β2) are charged by the switching pattern of the fourth mode in a period from the time t36 to a time t37. In a period from the time t37 to a time t38, both of the β-phase first coil 33 (β1) and the β-phase second coil 34 (β2) are discharged by the switching pattern of the second mode. In a period from the time t38 to a time t39, both of the β-phase first coil 33 (β1) and the β-phase second coil 34 (β2) are charged by the switching pattern of the first mode. In a period from the time t39 to a time t40, both of the β-phase first coil 33 (β1) and the β-phase second coil 34 (β2) are discharged by the switching pattern of the second mode. In a period from the time t40 to the time t41, both of the β-phase first coil 33 (β1) and the β-phase second coil 34 (β2) are charged by the switching pattern of the fourth mode.

As understood from the above description, in accordance with the decrease of the first duty command value D1 toward 0.5 from 1, the first mode and the fourth mode in which the β-phase coils 33 (β1), 34 (β2) are charged are increased, and the second mode in which the β-phase coils 33 (β1), 34 (β2) are discharged is decreased. For example, when the first duty command value D1 is 0.5, there are only the first mode and the fourth mode in which the β-phase coils 33 (β1), 34 (β2) are charged. For example, in accordance with the decrease of the first duty command value D1 toward 0 from 0.5, the first mode and the fourth mode in which the β-phase coils 33 (β1), 34 (β2) are charged are decreased, and the third mode in which the β-phase coils 33 (β1), 34 (β2) are discharged is increased.

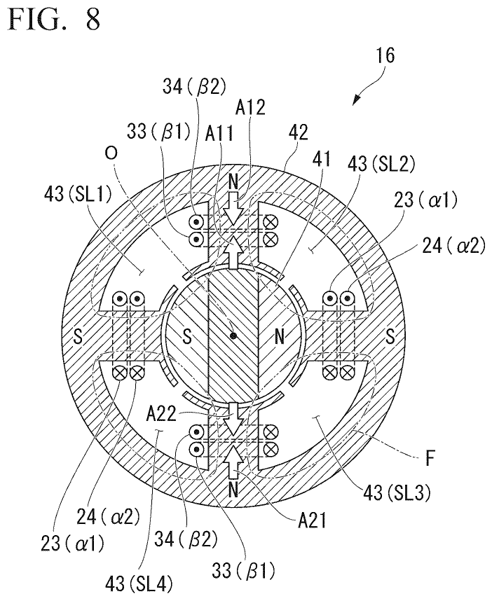

FIG. 8 is a view showing a direction of a magnetic flux that is generated in the rotary electric machine 16 by the PWM control portion 67 performing the two-coil driving described above at the time of AC charging. In FIG. 8, reference numerals A11, A21 represent a direction of a magnetic flux that is generated in the β-phase first coil 33 (β1), and reference numerals A12, A22 represent a direction of a magnetic flux that is generated in the β-phase second coil 34 (β2).

At the time of AC charging, the PWM control portion 67 performs the two-coil driving, and thereby, currents (currents that flow in an opposite direction to each other) of an opposite phase flow through the β-phase first coil 33 (β1) and the β-phase second coil 34 (β2). As a result, as shown in FIG. 8, magnetic fluxes are generated at the β-phase first coil 33 (β1) and the β-phase second coil 34 (β2) in a direction of canceling each other, and therefore, the charging torque at the time of AC charging becomes zero. In this way, the PWM control portion 67 performs the two-coil driving at the time of AC charging, and thereby, it is possible to reduce oscillation of the charging torque at the time of AC charging. However, when the PWM control portion 67 performs the two-coil driving, the inductance of the rotary electric machine 16 is decreased, and therefore, the ripple of the current that flows at the time of AC charging is increased.

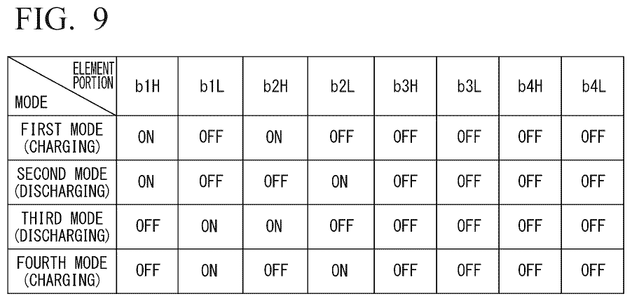

FIG. 9 is a view showing a switching pattern of the second electric power conversion portion 13 at the time of one-coil driving. As understood by comparing FIG. 4 and FIG. 9, the switching pattern of the second electric power conversion portion 13 at the time of one-coil driving is different from the switching pattern of the second electric power conversion portion 13 at the time of two-coil driving in that the element portions b3H, b3L, b4H, b4L included in the fourth full-bridge circuit 13b are in an OFF state in all modes.

A timing chart when the first duty command value D1 is equal to or more than 0 and less than 0.5 at the time of one-coil driving corresponds to a timing chart obtained by removing “b3H”, “b3L”, “b4H”, and “b4L” from the timing chart of FIG. 5. Therefore, hereinafter, with reference to FIG. 5, the state of the element portions b1H, b1L, b2H, b2L included in the third full-bridge circuit 13a when the first duty command value D1 is equal to or more than 0 and less than 0.5 at the time of one-coil driving is described.

At the time of one-coil driving, the PWM control portion 67 compares the magnitude of the first duty command value D1 with the magnitude of the carrier wave CW, and when the first duty command value D1 is less than the value of the carrier wave CW, the PWM control portion 67 generates a control signal such that the high-side arm element portion b2H is in an OFF state, and the low-side arm element portion b2L is in an ON state. Further, at the time of one-coil driving, when the first duty command value D1 is equal to or more than the value of the carrier wave CW, the PWM control portion 67 generates a control signal such that the high-side arm element portion b2H is in an ON state, and the low-side arm element portion b2L is in an OFF state.

At the time of one-coil driving, the PWM control portion 67 compares the magnitude of the second duty command value D2 with the magnitude of the carrier wave CW, and when the second duty command value D2 is less than the value of the carrier wave CW, the PWM control portion 67 generates a control signal such that the high-side arm element portion b1H is in an OFF state, and the low-side arm element portion b1L is in an ON state. Further, at the time of one-coil driving, when the second duty command value D2 is equal to or more than the value of the carrier wave CW, the PWM control portion 67 generates a control signal such that the high-side arm element portion b1H is in an ON state, and the low-side arm element portion b1L is in an OFF state.

At the time of one-coil driving, the PWM control portion 67 generates a control signal such that all of the element portions b3H, b3L, b4H, b4L included in the fourth full-bridge circuit 13b are in an OFF state regardless of the first duty command value D1 and the second duty command value D2.

With reference to FIG. 5, when the first duty command value D1 is equal to or more than 0 and less than 0.5 at the time of one-coil driving, only the β-phase first coil 33 (β1) is charged by the switching pattern of the fourth mode shown in FIG. 9 in the period from the time t1 to the time t2. In the period from the time t2 to the time t3, only the β-phase first coil 33 (β1) is discharged by the switching pattern of the third mode. In the period from the time t3 to the time t4, only the β-phase first coil 33 (β1) is charged by the switching pattern of the first mode shown in FIG. 9. In the period from the time t4 to the time t5, only the β-phase first coil 33 (β1) is discharged by the switching pattern of the third mode shown in FIG. 9. In the period from the time t5 to the time t6, only the β-phase first coil 33 (β1) is charged by the switching pattern of the fourth mode shown in FIG. 9.

The state of the element portions b1H, b1L, b2H, b2L in the period from the time t6 to the time t11 is the same as the state of the element portion b1H, b1L, b2H, b2L in the period from the time t1 to the time t6.

A timing chart when the first duty command value D1 is 0.5 at the time of one-coil driving corresponds to a timing chart obtained by removing “b3H”, “b3L”, “b4H”, and “b4L” from the timing chart of FIG. 6. Therefore, hereinafter, with reference to FIG. 6, the state of the element portions b1H, b1L, b2H, b2L included in the third full-bridge circuit 13a when the first duty command value D 1 is 0.5 at the time of one-coil driving is described.

With reference to FIG. 6, when the first duty command value D1 is 0.5 at the time of one-coil driving, only the β-phase first coil 33 (β1) is charged by the switching pattern of the fourth mode shown in FIG. 9 in the period from the time t21 to the time t22. In the period from the time t22 to the time t23, only the β-phase first coil 33 (β1) is charged by the switching pattern of the first mode shown in FIG. 9. In the period from the time t23 to the time t24, only the β-phase first coil 33 (β1) is charged by the switching pattern of the fourth mode shown in FIG. 9.

The state of the element portions b1H, b1L, b2H, b2L in the period from the time t24 to the time t27 is the same as the state of the element portions b1H, b1L, b2H, b2L in the period from the time t21 to the time t24.

A timing chart when the first duty command value D1 is equal to or less than 1 and more than 0.5 at the time of one-coil driving corresponds to a timing chart obtained by removing “b3H”, “b3L”, “b4H”, and “b4L” from the timing chart of FIG. 7. Therefore, hereinafter, with reference to FIG. 7, the state of the element portions b1H, b1L, b2H, b2L included in the third full-bridge circuit 13a when the first duty command value D1 is equal to or less than 1 and more than 0.5 at the time of one-coil driving is described.

With reference to FIG. 7, when the first duty command value D1 is equal to or less than 1 and more than 0.5 at the time of one-coil driving, only the β-phase first coil 33 (β1) is charged by the switching pattern of the fourth mode shown in FIG. 9 in the period from the time t31 to the time t32. In the period from the time t32 to the time t33, only the β-phase first coil 33 (β1) is discharged by the switching pattern of the second mode shown in FIG. 9. In the period from the time t33 to the time t34, only the β-phase first coil 33 (β1) is charged by the switching pattern of the first mode shown in FIG. 9. In the period from the time t34 to the time t35, only the β-phase first coil 33 (β1) is discharged by the switching pattern of the second mode shown in FIG. 9. In the period from the time t35 to the time t36, only the β-phase first coil 33 (β1) is charged by the switching pattern of the fourth mode shown in FIG. 9.

The state of the element portions b1H, b1L, b2H, b2L in the period from the time t36 to the time t41 is the same as the state of the element portions b1H, b1L, b2H, b2L in the period from the time t31 to the time t36.

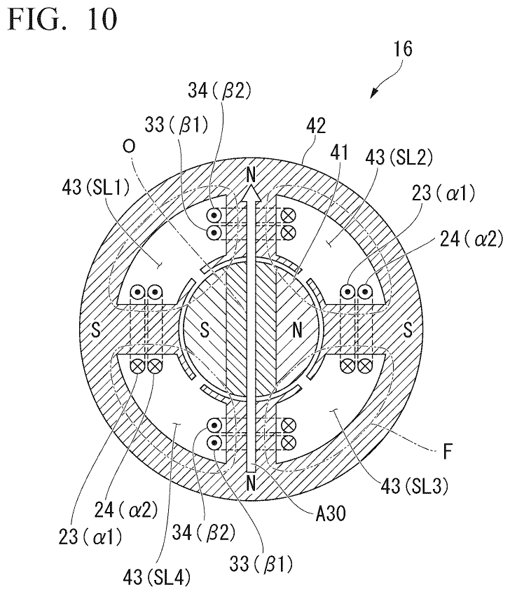

FIG. 10 is a view showing a direction of a magnetic flux that is generated in the rotary electric machine 16 by the PWM control portion 67 performing the one-coil driving described above at the time of AC charging. In FIG. 10, reference numeral A30 represents a direction of a magnetic flux that is generated in the rotary electric machine 16.

At the time of AC charging, the PWM control portion 67 performs the one-coil driving, and thereby, a current flows only through the β-phase first coil 33 (β1). As a result, as shown in FIG. 10, a magnetic flux is generated from the β-phase first coil 33 (β1) that is wound around one teeth portion among a pair of teeth portions that face each other and interpose the rotor 31 toward the β-phase first coil 33 (β1) that is wound around the other teeth portion. In this way, the PWM control portion 67 performs the one-coil driving at the time of AC charging, and thereby, the charging torque is generated; however, the inductance of the rotary electric machine 16 is increased, and therefore, the ripple of the current that flows at the time of AC charging is decreased.

As described above, the PWM control portion 67 performs the two-coil driving at the time of AC charging, and thereby, it is possible to reduce oscillation of the charging torque at the time of AC charging, but the ripple of the current that flows at the time of AC charging is increased. On the other hand, the PWM control portion 67 performs the one-coil driving at the time of AC charging, and thereby, the charging torque is generated, but the ripple of the current that flows at the time of AC charging is decreased. In this way, there are mutually contradictory advantages and disadvantages between the two-coil driving and the one-coil driving.

Therefore, at the time of AC charging, the PWM control portion 67 switches between the two-coil driving and the one-coil driving in accordance with the charging torque and thereby charges the electric power storage device 11. More specifically, for example, the PWM control portion 67 charges the electric power storage device 11 by the one-coil driving when a charging torque T is less than a predetermined value Ta, and the PWM control portion 67 charges the electric power storage device 11 by the two-coil driving when the charging torque T is equal to or more than the predetermined value Ta.

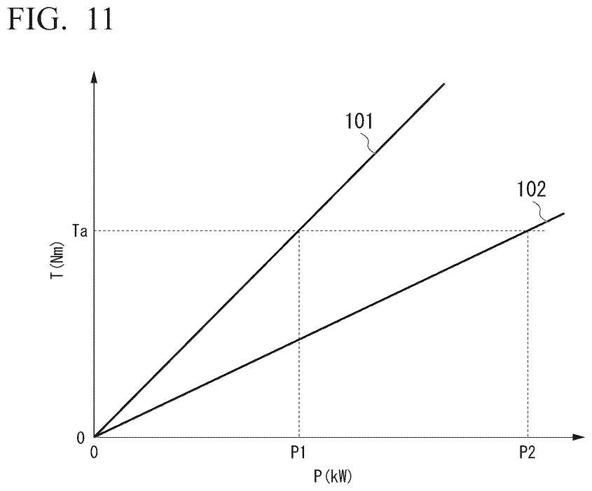

FIG. 11 is a view showing a correspondence relationship between the charging electric power P and the charging torque T. In FIG. 11, a straight line 101 indicates the charging torque T with respect to the charging electric power P when the rotor angle θ is 90 degrees, and a straight line 102 indicates the charging torque T with respect to the charging electric power P when the rotor angle θ is 45 degrees. In the case where the rotor angle θ is 90 degrees, when the charging electric power P is larger than P1, the charging torque T becomes larger than the predetermined value Ta. Further, in the case where the rotor angle θ is 45 degrees, when the charging electric power P is larger than P2, the charging torque T becomes larger than the predetermined value Ta.

As described above, the magnitude of the charging torque T with respect to the charging electric power P changes depending on the rotor angle θ. Therefore, the PWM control portion 67 calculates the charging torque T on the basis of the rotor angle θ and compares the calculated charging torque T with the predetermined value Ta. For example, the PWM control portion 67 calculates the charging torque T on the basis of Equation (1) described below. In Equation (1) described below, I is a charging current, and K is a coefficient determined by the specification of the rotary electric machine 16.

T=K×I×sin θ (1)

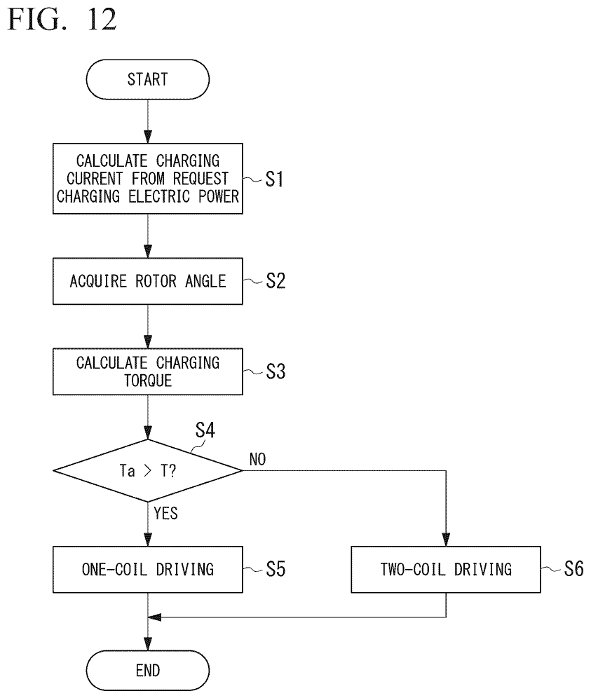

In consideration of the operation of the PWM control portion 67 described above, a charging control process performed by the PWM control portion 67 at the time of AC charging is described with reference to FIG. 12. FIG. 12 is a flowchart showing the charging control process performed by the PWM control portion 67 at the time of AC charging.

For example, at the time of AC charging, the PWM control portion 67 performs the charging control process shown in FIG. 12 each time a bottom point of a valley of the carrier wave CW which is a triangular wave arrives. In other words, the PWM control portion 67 performs the charging control process each time a start time point of one cycle Tc of the carrier wave CW arrives.

As shown in FIG. 12, when the charging control process is started, the PWM control portion 67 first calculates a charging current I from a request charging electric power (Step S1). Subsequently, the PWM control portion 67 acquires the rotor angle θ from the rotor angle acquisition portion 68 (Step S2). Subsequently, the PWM control portion 67 substitutes the charging current I and the rotor angle θ into Equation (1) described above and thereby calculates the charging torque T (Step S3).

Subsequently, the PWM control portion 67 determines whether or not the calculated charging torque T is smaller than the predetermined value Ta (Step S4). When the PWM control portion 67 determines that the charging torque T is smaller than the predetermined value Ta (Step S4: YES), the PWM control portion 67 performs the one-coil driving on the basis of the duty command value (the first duty command value D1 and the second duty command value D2) acquired from the current control portion 65 and thereby charges the electric power storage device 11 (Step S5).

On the other hand, when the PWM control portion 67 determines that the charging torque T is equal to or more than the predetermined value Ta (Step S4: NO), the PWM control portion 67 performs the two-coil driving on the basis of the duty command value (the first duty command value D1 and the second duty command value D2) acquired from the current control portion 65 and thereby charges the electric power storage device 11 (Step S6).

As described above, at the time of AC charging, the PWM control portion 67 charges the electric power storage device 11 by the one-coil driving when the charging torque T is smaller than the predetermined value Ta, and the PWM control portion 67 charges the electric power storage device 11 by the two-coil driving when the charging torque T is equal to or more than the predetermined value Ta.

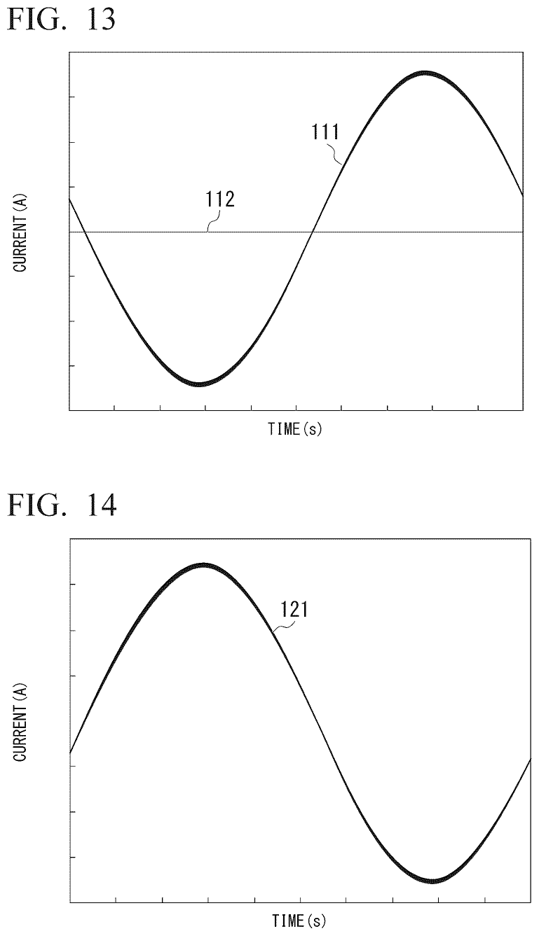

FIG. 13 is a view showing an example of a waveform 111 of a current that flows in the β-phase first coil 33 (β1) and a waveform 112 of a current that flows in the β-phase second coil 33 (β2) at the of one-coil driving. FIG. 14 is a view showing an example of a waveform 121 of an electric power source current that flows at the time of one-coil driving. As shown in FIG. 13 and FIG. 14, by the PWM control portion 67 performing the one-coil driving, a charging torque is generated, but the ripple of the current that flows in the β-phase first coil 33 (β1) and the ripple of the electric power source current become relatively small. As shown in FIG. 13, at the time of one-coil driving, the value of the current that flows in the β-phase second coil 33 (β2) is zero.

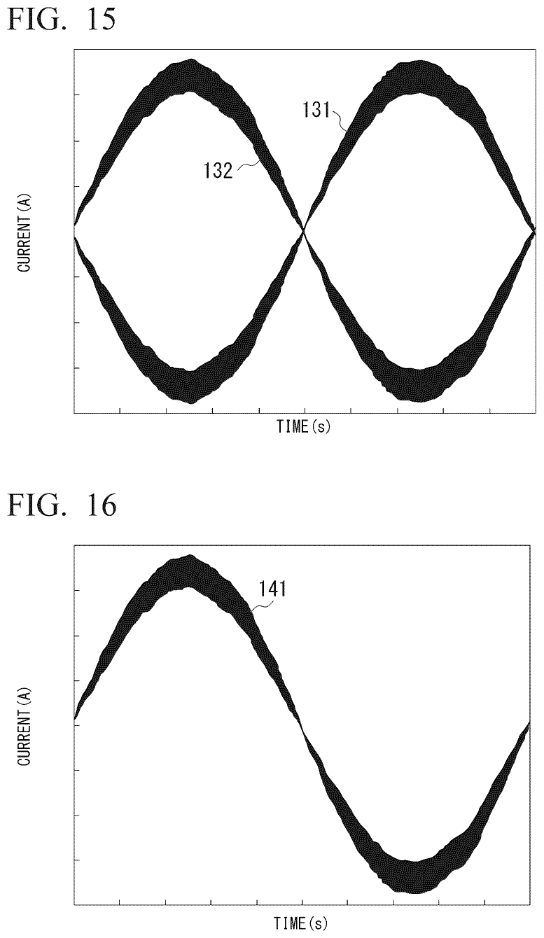

FIG. 15 is a view showing an example of a waveform 131 of a current that flows in the β-phase first coil 33 (β1) and a waveform 132 of a current that flows in the β-phase second coil 33 (β2) at the time of two-coil driving. FIG. 16 is a view showing an example of a waveform 141 of an electric power source current that flows at the time of two-coil driving. As shown in FIG. 15 and FIG. 16, by the PWM control portion 67 performing the two-coil driving, the charging torque becomes zero, but the ripple of the current that flows in the β-phase first coil 33 (β1) and the β-phase second coil 33 (β2) and the ripple of the electric power source current become relatively large.

As described above, according to the electric apparatus 10 of the present embodiment, when the charging torque T at the time of AC charging is equal to or more than the predetermined value Ta, by supplying electric power to both of the β-phase first coil 33 (β1) and the β-phase second coil 34 (β2) such that the magnetic fluxes of the β-phase first coil 33 (β1) and the β-phase second coil 34 (β2) cancel each other, it is possible to reduce oscillation of the charging torque that is generated in the rotary electric machine 16, and it is possible to increase a voltage increase ratio by a relatively small inductance. On the other hand, when the charging torque T at the time of AC charging is less than the predetermined value Ta, by supplying electric power to one of the β-phase first coil 33 (β1) and the β-phase second coil 34 (β2), it is possible to improve the charging efficiency while reducing the ripple of the current by a relatively large inductance.

Further, according to the electric apparatus 10 of the present embodiment, the time at which the charging torque T exceeds the predetermined value Ta can be detected with high accuracy since the charging torque T that changes depending on the rotor angle θ can be calculated with high accuracy.

Further, according to the electric apparatus 10 of the present embodiment, it is possible to reduce oscillation of the charging torque that is generated in the rotary electric machine 16 and possible to increase a voltage increase ratio by a relatively small inductance by employing a structure in which the β-phase first coil 33 (β1) and the β-phase second coil 34 (β2) are wound around the identical slot of the identical phase in the rotary electric machine 16 and by supplying electric power to both of the β-phase first coil 33 (β1) and the β-phase second coil 34 (β2) such that the magnetic fields of the β-phase first coil 33 (β1) and the β-phase second coil 34 (β2) cancel each other.

Further, according to the electric apparatus 10 of the present embodiment, it is possible to cause the electric power control unit 10a to function as an inverter of a multiplex full-bridge circuit at the time of driving of the rotary electric machine 16 by the electric power storage device 11. At the time of AC charging of the electric power storage device 11 by the external AC electric power source, it is possible to cause the combination of the α-phase first coil 23 (α1), the α-phase second coil 24 (α2), the first full-bridge circuit 12a, and the second full-bridge circuit 12b to function as an insulation-type bidirectional DC-DC converter. For example, in the case of the voltage increase operation at the time of AC charging, it is possible to perform quick charging with respect to a voltage of the electric power storage device 11 that is higher than a charging voltage by the external AC electric power source.

Further, according to the electric apparatus 10 of the present embodiment, a magnetic coupling degree between the α-phase first coil 23 (α1) and the α-phase second coil 24 (α2) can be enhanced by employing a structure in which the α-phase first coil 23 (α1) and the α-phase second coil 24 (α2) are wound around the identical slot in the rotary electric machine 16, and therefore, it is possible to improve the charging efficiency.

Although an embodiment of the present invention has been described, the present invention is not limited to the embodiment described above, and various modifications and substitutions can be made without departing from the scope of the present invention.

For example, the above embodiment is described using an example in which the PWM control portion 67 switches between the two-coil driving and the one-coil driving in accordance with the charging torque T; however, the PWM control portion 67 may switch between the two-coil driving and the one-coil driving in accordance with charging electric power or a charging current determined from charger information, battery information, the rotor angle, a torque threshold value, and the like.

Further, the above embodiment is described using an example in which the PWM control portion 67 supplies electric power to the β-phase first coil 33 (β1) when performing the one-coil driving; however, the PWM control portion 67 may supply electric power to the β-phase second coil 33 (β2) when performing the one-coil driving.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. An electric apparatus comprising:
an electric power storage device;
a rotary electric machine;
an electric power control unit that is connected to the electric power storage device and the rotary electric machine and controls electric power transfer of each of the electric power storage device and the rotary electric machine; and
an AC charging terminal that connects the electric power control unit to an external AC electric power source,
wherein the rotary electric machine comprises a first coil and a second coil,
the electric power control unit comprises
a first full-bridge circuit that is connected to both ends of the first coil,
a second full-bridge circuit that is connected to both ends of the second coil,
a first connection-disconnection device that is connected between the first full-bridge circuit and one end of the first coil,
a second connection-disconnection device that is connected between the second full-bridge circuit and one end of the second coil, and
a control device that controls electric power supply to the first coil and the second coil,
the AC charging terminal is connected to both ends of each of the first connection-disconnection device and the second connection-disconnection device such that when a current supplied from the external AC electric power source flows to the first coil and the second coil that are magnetically coupled, magnetic fluxes of the first coil and the second coil cancel each other, and
the control device
controls the first connection-disconnection device and the second connection-disconnection device to be in a disconnection state at a time of AC charging in which the electric power storage device is charged by electric power supplied from the external AC electric power source,
supplies electric power to both of the first coil and the second coil when a charging torque generated at the time of AC charging is equal to or more than a predetermined value, and
supplies electric power to one of the first coil and the second coil when the charging torque is less than the predetermined value.

2. The electric apparatus according to claim 1, further comprising:
a position sensor that detects a rotor angle of the rotary electric machine,
wherein the control device calculates the charging torque based on the rotor angle obtained from an output signal of the position sensor.

3. The electric apparatus according to claim 1,
wherein in the rotary electric machine, the first coil and the second coil are wound around an identical slot of an identical phase, and
the control device controls a flow direction of a current supplied from the external AC electric power source such that the magnetic fluxes of the first coil and the second coil cancel each other when supplying electric power to both of the first coil and the second coil.

4. The electric apparatus according to claim 1,
wherein the rotary electric machine comprises a third coil and a fourth coil having a phase that is orthogonal to the first coil and the second coil, and
the electric power control unit comprises
a third full-bridge circuit that is connected to both ends of the third coil,
a fourth full-bridge circuit that is connected to both ends of the fourth coil,
a third connection-disconnection device that is connected between positive electrodes of the third full-bridge circuit and the fourth full-bridge circuit, and
a fourth connection-disconnection device that is connected between negative electrodes of the third full-bridge circuit and the fourth full-bridge circuit.

5. The electric apparatus according to claim 4,
wherein in the rotary electric machine, the third coil and the fourth coil are wound around an identical slot.

6. The electric apparatus according to claim 2,
wherein the rotary electric machine comprises a third coil and a fourth coil having a phase that is orthogonal to the first coil and the second coil, and
the electric power control unit comprises
a third full-bridge circuit that is connected to both ends of the third coil,
a fourth full-bridge circuit that is connected to both ends of the fourth coil,
a third connection-disconnection device that is connected between positive electrodes of the third full-bridge circuit and the fourth full-bridge circuit, and
a fourth connection-disconnection device that is connected between negative electrodes of the third full-bridge circuit and the fourth full-bridge circuit.

7. The electric apparatus according to claim 6,
wherein in the rotary electric machine, the third coil and the fourth coil are wound around an identical slot.

8. The electric apparatus according to claim 3,
wherein the rotary electric machine comprises a third coil and a fourth coil having a phase that is orthogonal to the first coil and the second coil, and
the electric power control unit comprises
a third full-bridge circuit that is connected to both ends of the third coil,
a fourth full-bridge circuit that is connected to both ends of the fourth coil,
a third connection-disconnection device that is connected between positive electrodes of the third full-bridge circuit and the fourth full-bridge circuit, and
a fourth connection-disconnection device that is connected between negative electrodes of the third full-bridge circuit and the fourth full-bridge circuit.

9. The electric apparatus according to claim 8,
wherein in the rotary electric machine, the third coil and the fourth coil are wound around an identical slot.
